(19) United States
(12) Patent Application Publication
(10) Pub. No.: US 2007/0018852 A1
(43) Pub. Date: Jan. 25, 2007

(54) Power load pattern monitoring system

(76) Inventor: Shane Michael Seitz, Oliver (CA)

Correspondence Address: ANTONY C. EDWARDS, SUITE 200 - 270 HIGHWAY 33 WEST, KELOWNA, BC, V1X 1X7, CA

(21) Appl. No.: 11/488,770

(22) Filed: Jul. 19, 2006

Related U.S. Application Data
(60) Provisional application No. 60/701,340, filed on Jul. 19, 2005.

(51) Int. Cl. G08B 21/00

(52) U.S. Cl. 340/870.16

(57) ABSTRACT

A power load pattern monitoring system for external monitoring of electrical consumption within a building structure includes a sensor sensing the amount of electrical consumption through an electrical conduit supplying electricity to the building structure, means for sampling the amount of electrical consumption sensed by the sensor to produce corresponding sample data, and at least one processor for analyzing the sample data to detect a load pattern indicating an electrical consumption consistent with a plant growing operation and, for signalling a user when the load pattern is detected.

### CROSS REFERENCE TO RELATED APPLICATION

This application claims priority from U.S. Provisional Patent Application No. 60/701,340 filed Jul. 19, 2005 entitled Power Load Pattern Monitor.

### FIELD OF THE INVENTION

This invention relates to a power-monitoring device that detects electrical current drawn through the power transmission supply line typically connected to a single family dwelling or light commercial buildings that are rented out. The load monitoring function of this device is not to meter the absolute power consumption at the property, but to detect load patterns that are indicative of indoor green house operations typical of illicit marijuana growing operations. Such load-monitoring device would be located such that it could not be defeated or tampered with, and would communicate with a central load monitoring system. The central system monitors multiple distributed load monitoring devices for the purpose of load pattern analysis on a property by property basis and alarming when a property load pattern matches that of a growing operation.

### BACKGROUND OF THE INVENTION

Landlords renting single-family dwellings and apartments are facing the growing problem of their properties being potentially used for the illicit cultivation of marijuana. Such indoor cultivation often results in damage to the property due to the renovation, heat and humidity involved with the growing operation. Many communities are now making Landlords liable for community related costs due to such growing operations. Seventy five percent of illicit growing operations occur inside a house or apartment which is typically rented, as documented in a March 2005 study conducted by the Department of Criminology and Criminal Justice, University College of the Fraser Valley, and the International Center for Urban Research Studies, titled “Marijuana Growing Operations In British Columbia Revisited 1997-2003”. Indoor growing is generally conducted using hydroponic means requiring significant lighting and therefore power consumption, resulting in theft of power in about twenty-one percent of the cases. The lighting period for the marijuana plants is typically twelve hours, followed by twelve hours of darkness. This may vary somewhat particularly when carbon dioxide enrichment is used in the growing process, in which case the lighting period can be on the order of eight hours.

The power consumption pattern of a grow operation is therefore quite distinctive in that a large amount of power will be consumed for a period of eight to twelve hours in a twenty-four hour period.

It is known that electronic metering of power consumption has evolved to permit telemetry of power consumption information to the power delivery company primarily for the purposes of billing. Telemetry of consumption information can be achieved using carrier modem, telephone, local and wide area networking, and radio frequency transmission. Typically the electronic meters are placed in the meter housing in which the conventional inductive wheel analog meter would normally be situated. Given its accessibility the electronic meter may be tampered with and or bypassed as is typical in about twenty percent of illicit marijuana growing operations.

In the prior art applicant is aware of U.S. Pat. No. 6,538,577 which issued Mar. 25, 2003 to Ehrke et al. for an Electronic Electric Meter For Networked Meter Reading. Ehrke et al disclose an electric meter which measures electricity usage for transmission to a utility over, for example, a two-way nine hundred Mhz spread spectrum local area network. The meter is taught to incorporate automatic meter reading functions including usage readings, outage detection, tamper detection and notification, load profiling, etc. A virtual shut-off function is provided for when a residence is vacated if there is any meter movement indicating unauthorized usage a tamper switch provides a means of flagging and reporting metered movement beyond a pre-set threshold value.

### SUMMARY OF THE INVENTION

The present invention serves to detect the power consumption pattern that is representative of an indoor marijuana growing operation so that intervention by the landlord and law enforcement authorities can be executed in a timely manner thereby reducing the risk of further damage to the property and community. Furthermore, the detection is performed on the power line connecting the property to the distribution line, with the detector located proximal to the connection point to the distribution line to minimize the likelihood of tampering or bypass.

In summary, the power load pattern monitoring system of the present invention for external monitoring of electrical consumption within a building structure, may be characterized in one aspect as including a sensor sensing the amount of electrical consumption through an electrical conduit supplying electricity to the building structure, wherein the sensor is adapted for mounting to the electrical conduit at a remote location remote from the building structure; means for sampling the amount of electrical consumption sensed by the sensor to produce corresponding sample data; and at least one processor including means for analyzing the sample data to detect a load pattern indicating an electrical consumption consistent with a plant growing operation, and means for signalling a user when the load pattern is detected The corresponding method of external monitoring of the power load pattern of electrical consumption within the building structure includes the steps of:
a) providing the sensor and mounting the sensor to the electrical conduit supplying electricity to the building structure at a remote location remote from the building structure;
b) sensing the amount of electrical consumption through the electrical conduit;
c) sampling the amount of electrical consumption sensed by the sensor to produce corresponding sample data;
d) providing at least one processor cooperating with the sensor;
e) analyzing the sample data to detect the load pattern indicating the electrical consumption consistent with a plant growing operation; and,
f) signalling a user when the load pattern is detected.

The present invention may also include providing a data recorder and recording the sample data with the data recorder. The sensor may also include at least one electrical current transformer mounted into cooperating proximity to the electrical conduit, so as to produce an electrical signal commensurate with electrical current in the conduit. The electrical signal from each transformer is sampled. A pair of transformers may be provided so as to simultaneously sense at least two electrical phases in the conduit.

A remote computer may be provided remote from the sensor. A means for communicating between the sensor and the remote computer is provided for communicating data between the sensor and the remote computer. At least the step of signalling of the user is done by the remote computer. The data sampling and analyzing steps may be done in a processor located at the sensor or in a processor in the remote computer. In one embodiment the means for communicating includes a first wireless communicator mounted in cooperation with the sensor and a second wireless commuricator cooperating with the remote computer for communicating the data between the first and second wireless communicators.

The step of analyzing the data sample may include detecting electrical consumption which exceeds a pre-determined threshold for a pre-determined period. The pre-determined threshold may be determined by monitoring electrical load over time to derive a typical load pattern. For example the typical load pattern may be established by historical load pattern data for the building structure. The pre-determined period may be a time period or a pre-set number of samples in the sample data. The step of analyzing the data sample may include detecting an increase in a rate of electrical consumption in the building above a pre-determined or threshold rate of consumption.

### BRIEF DESCRIPTION OF THE DRAWINGS

FIG. 1 is a 24 hour chart of two phase current consumption for a typical house.

FIG. 2 is a 24 hour chart of two phase current consumption for both a typical house and for a house with a growing operation.

FIG. 3 is an isometric view of a house connected to the power distribution by overhead wires with a load sensor of the present invention installed proximal to the power line.

FIG. 4 is a schematic diagram of a load-monitoring sensor.

FIG. 5 is a block diagram illustrating a system according to the present invention wherein a load sensor communicates with a remote computer.

FIG. 6 is a schematic diagram of a radio frequency modem computer interface for connecting the RF network of load-monitoring sensors to the central load monitoring computer.

### DETAILED DESCRIPTION OF EMBODIMENTS OF THE INVENTION

The present invention is a monitoring sensor that detects power load patterns for a property, typically a single family dwelling or apartment, and reports those patterns through telemetry to a power usage monitoring system consisting of a radio frequency receiver with integrated modem connected to a computer based database system for automatic monitoring and alarming of load patterns consistent with illicit growing operations that provides notification to the property owner, and potentially law enforcement officials.

The electrical current consumed by a household is measured using current transformers in axial proximity to the power lines that service the property. The current transformer output is digitized and stored in memory of a microcontroller for a set period of time. The microcontroller can be programmed to evaluate the power load pattern, and transmit the power usage information and alarms to the monitoring system by a Radio Frequency coupled modem or other communication device including a wireless communication device.

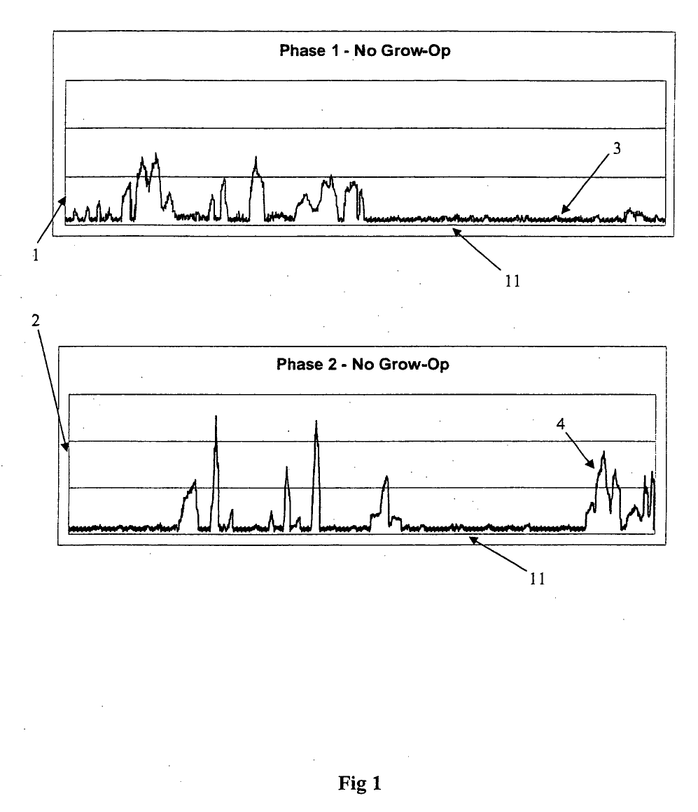

By way of example, assuming the use of conventional two phase alternating current, the load pattern or current consumption pattern of a typical single family dwelling is exemplified or similar to those shown for the two phases (phase I and phase 2) in FIG. 1. The vertical axis of the two graphs indicate current consumed as measured in amperes for both phase 1, and phase 2. The graph spans a twenty-four hour period as represented by the horizontal axis resulting in plot 3 for the 24 current consumption on phase 1 and plot 4 for phase 2.

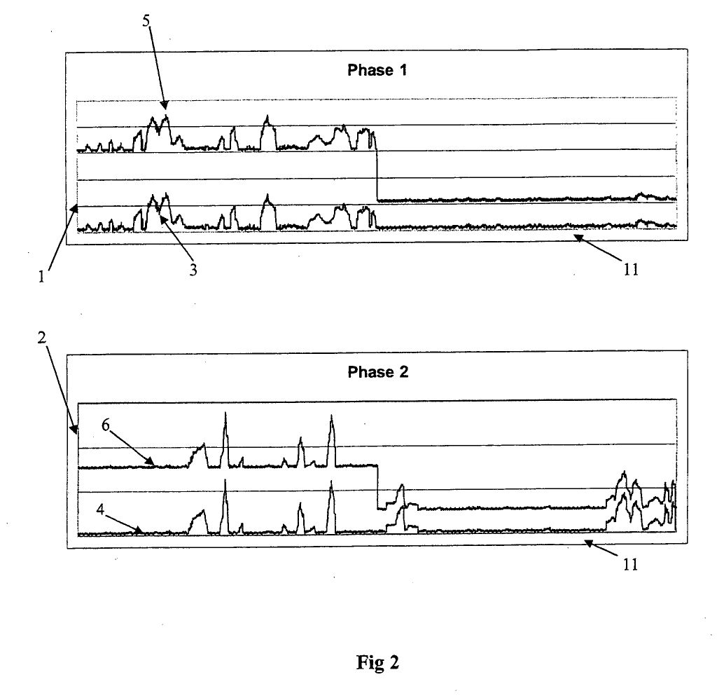

The “typical normal” load patterns 3 and 4 are shown in FIG. 2 in comparison with load patterns typical of a growing operation as indicated by plot 5 for phase 1 and plot 6 for phase 2. In this example the average current consumed by the growing operation is at a sustained high level for a period of approximately 12 hours, and returns to “typical normal” level for the remaining 12 hours. In this example the loading appears to be relatively balanced between the phases as indicated by plots 5 & 6 representing phase 1 and phase 2. This may not be the case as the growing operation loading may be asymmetric for the two phases. However one or both of the phases will exhibit the 8-12 hour sustained high level of current consumption pattern indicative of a growing operation present on the property.

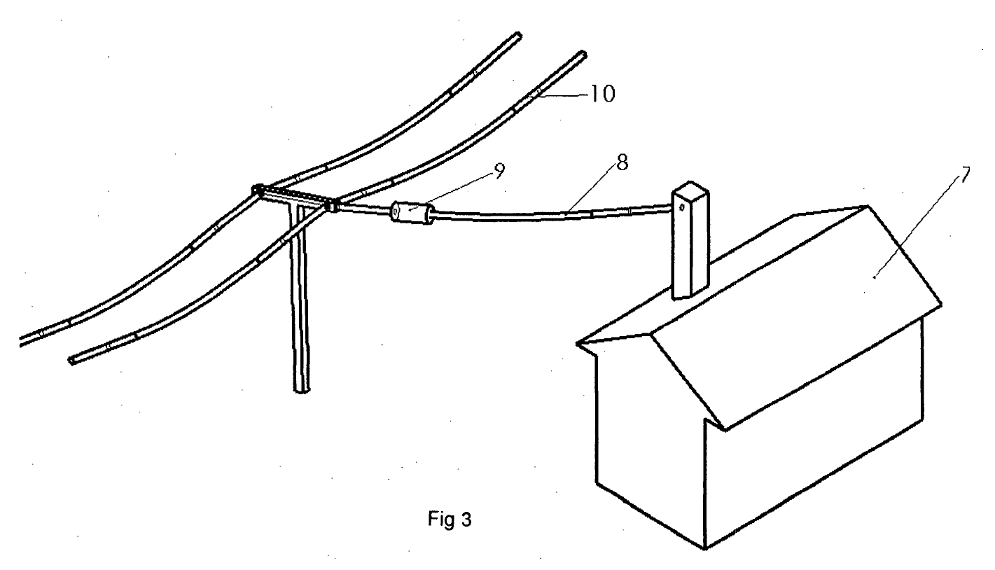

The load sensor 9 shown in FIG. 3 is typically mounted on the power line 8 near, that is proximal to, the connection point of power line 8 to the power distribution line 10 for any property to be monitored. The depicted property here is a single family dwelling 7, although this is not intended to be limiting. Also, the depicted overhead power line distribution system is not intended to be limiting of this application, as load sensor 9 could be similarly be installed in a building or subterranean power distribution installations, provided adequate communications with the central load monitoring system are provided.

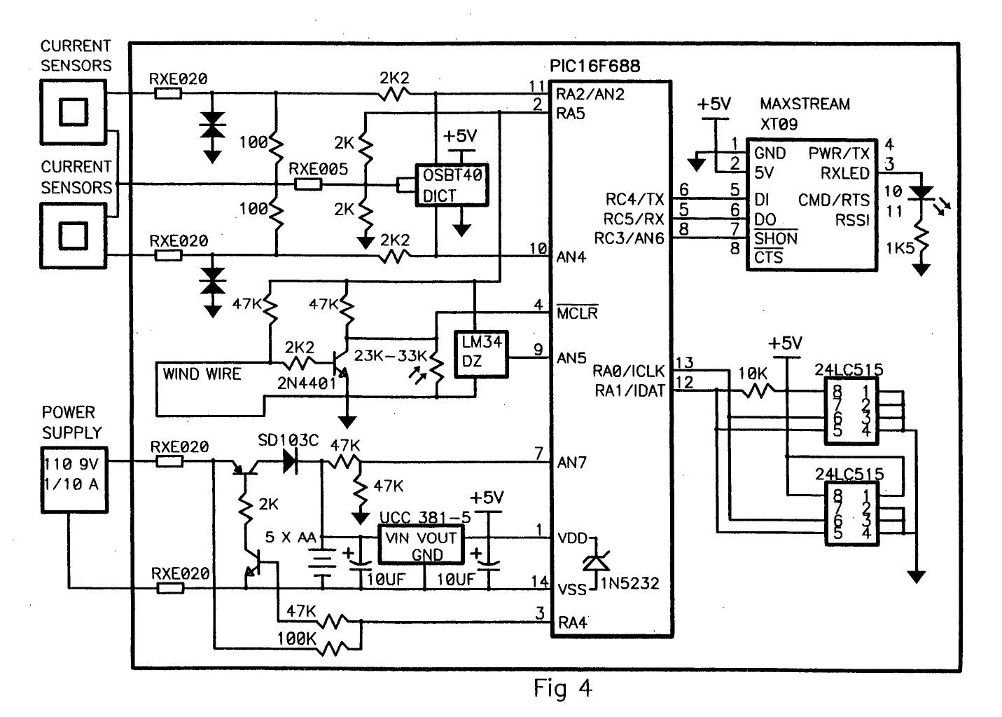

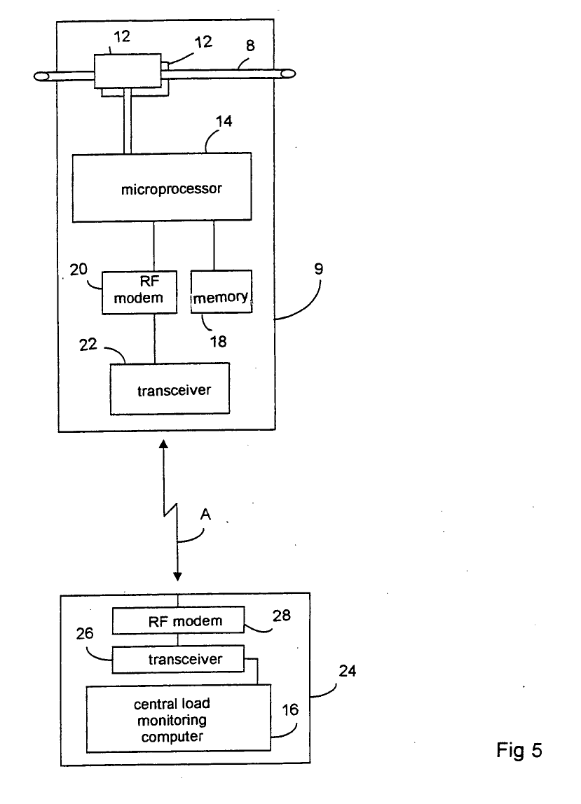

The embodiment of load sensor 9 as shown in FIG. 4 consists of a pair of current transformers 12 (the actual sensor element) to monitor the current flow in each of two phases of electrical alternating current. Each current transformer 12 is independently sampled on a specified time interval by a microprocessor including for example a microcontroller 14 such as but not limited to a PIC16F688 manufactured by Microchip Technology Inc of Chandler, Ariz., USA, (www.microchip.com). The programming of the microcontroller can accommodate a variety of operating modes. The most common mode would have each time based current sample digitized and stored in memory 18 for subsequent evaluation. The microcontroller 14 will typically transmit, for example at least once per day, the last twenty-four hours of current samples to a central load monitoring computer 16 via a modem 20 connected to a radio frequency transceiver 22, carrier line transceiver, telephone line or such other communication medium as would be known to one skilled in the art. In FIGS. 4 and 5 this preferred embodiment uses a radio frequency modem 20 and transceiver 22 connected to the microcontroller 14.

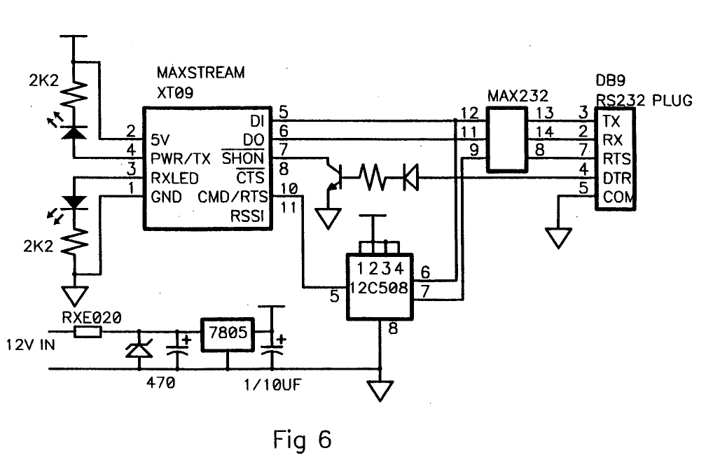

The transmitted signal A propagates to a central load monitoring system 24, which includes monitoring computer 16, and a complimentary transceiver 26 and modem 28 interfaced with the computer. A typical schematic for system 24 is shown in FIG. 6. Computer 16 is programmed to communicate with the load sensors and periodically receive, store and evaluate the current samples to detect load patterns indicative of growing operations such as plots 5 and 6 seen in FIG. 2. Once the central load-monitoring program has detected such a load pattern it will provide a report or alarm to inform the system operator and/or property owner of the load pattern detection, alerting them to follow up, investigate, and potentially intervene with the detected growing operation.

The preferred embodiment of the present invention uses encrypted spread spectrum 900 Mhz radio frequency modems 20 and 28 to protect the integrity of the system and the privacy of the properties being monitored.

Alternative embodiments of the present invention may include one way communication from the load sensors to the central computer. Another alternative embodiment includes load pattern evaluation in the sensor and the pattern detection status conveyed from the sensor to the central monitoring computer, thereby potentially reducing the amount of data to be transmitted.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A power load pattern monitoring system for external monitoring of electrical consumption within a building structure, the system comprising:
a sensor sensing the amount of electrical consumption through an electrical conduit supplying electricity to the building structure, wherein said sensor is adapted for mounting to the electrical conduit at a remote location remote from the building structure,
means for sampling the amount of electrical consumption sensed by said sensor to produce corresponding sample data,
at least one processor comprising:
(a) means for analyzing said sample data to detect a load pattern indicating an electrical consumption consistent with a plant growing operation; and,
(b) means for signalling a user when said load pattern is detected.

2. The system of claim 1 further comprising a data recorder recording said sample data.

3. The system of claim 1 wherein said sensor includes at least one electrical current transformer mountable into cooperating proximity to said electrical conduit so that electrical current in said conduit causes said at least one electrical current transformer to produce a commensurate electrical signal to be sampled by said means for sampling.

4. The system of claim 3 wherein said at least one electrical current transformer includes a pair of transformers and wherein at least two electrical phases are simultaneously sensed by said sensor.

5. The system of claim 1 further comprising a remote computer remote from said sensor and a means for communicating between said sensor and said remote computer, and wherein at least said signalling of said user is done by a processor of said at least one processor within said remote computer.

6. The system of claim 5 wherein said means for communicating includes a first wireless communicator mounted in cooperation with said sensor and a second wireless communicator cooperating with said remote computer, wherein said first and second wireless communicators are in wireless data communication therebetween.

7. The system of claim 1 wherein said load pattern includes electrical consumption exceeding a pre-determined threshold; and wherein said at least one processor determines when said sample data exceeds said threshold for a pre-determined period.

8. The system of claim 7 wherein said pre-determined threshold is determined by monitoring electrical load over time to derive a typical load pattern.

9. The system of claim 8 wherein said typical load pattern is established by historical load pattern data for said building structure.

10. The system of claim 7 wherein said period is a time period.

11. The system of claim 7 wherein said period is a pre-set number of samples in said sample data.

12. The system of claim 1 wherein said load pattern is indicated by at least an increase in a rate of electrical consumption above a pre-determined rate of consumption.

13. The system of claim 5 wherein said analyzing said sample data is processed in said remote computer.

14. Within a power load pattern monitoring system for external monitoring of electrical consumption within a building structure, wherein the system includes: a sensor sensing the amount of electrical consumption through an electrical conduit supplying electricity to the building structure, wherein the sensor is adapted for mounting to the electrical conduit at a remote location remote from the building structure, means for sampling the amount of electrical consumption sensed by the sensor to produce corresponding sample data, and at least one processor including means for analyzing said sample data to detect a load pattern indicating an electrical consumption consistent with a plant growing operation, and means for signalling a user when said load pattern is detected, a method of external monitoring of the power load pattern of electrical consumption within the building structure, the method comprising the steps of:
a) providing a sensor and mounting said sensor to an electrical conduit supplying electricity to the building structure at a remote location remote from the building structure;
b) sensing the amount of electrical consumption through said electrical conduit;
c) sampling the amount of electrical consumption sensed by said sensor to produce corresponding sample data;
d) providing at least one processor cooperating with said sensor;
e) analyzing said sample data to detect a load pattern indicating an electrical consumption consistent with a plant growing operation; and,
f) signalling a user when said load pattern is detected.

15. The method of claim 14 further comprising the steps of providing a data recorder and recording said sample data with said data recorder.

16. The method of claim 14 further comprising the steps of providing within said sensor at least one electrical current transformer mounted into cooperating proximity to said electrical conduit, and producing an electrical signal to be sampled from said at least one current transformer commensurate with electrical current in said conduit.

17. The method of claim 16 wherein said at least one electrical current transformer includes a pair of transformers and wherein said method further comprises the step of simultaneously sensing at least two electrical phases in said conduit.

18. The method of claim 14 further comprising the steps of providing a remote computer remote from said sensor and a means for communicating between said sensor and said remote computer, and communicating data by said means for communicating between said sensor and said remote computer, wherein at least said step of signalling of said user is done by said remote computer.

19. The method of claim 18 further comprising the steps of providing, within said means for communicating, a first wireless communicator mounted in cooperation with said sensor and a second wireless communicator cooperating with said remote computer, and communicating said data between said first and second wireless communicators.

20. The method of claim 14 wherein said step of analyzing said data sample includes detecting electrical consumption which exceeds a pre-determined threshold for a pre-determined period.

21. The method of claim 20 wherein said pre-determined threshold is determined by monitoring electrical load over time to derive a typical load pattern.

22. The method of claim 21 wherein said typical load pattern is established by historical load pattern data for said building structure.

23. The method of claim 20 wherein said period is a time period.

24. The method of claim 20 wherein said period is a pre-set number of samples in said sample data.

25. The method of claim 14 wherein said step of analyzing said data sample includes detecting an increase in a rate of electrical consumption above a pre-determined rate of consumption.

26. The method of claim 18 wherein said step of analyzing said sample data is performed in said remote computer.
